(19) United States
(12) Patent Application Publication
(10) Pub. No.: US 2012/0173294 A1
(43) Pub. Date: Jul. 5, 2012

(54) Integrating Report Actions for a Series of Reports Within a Single User Interface

(75) Inventors: Jennifer F. Olson, West Fargo, ND (US); Brian A. Meier, Fargo, ND (US); Jay F. Winkis, Fargo, ND (US); Robert J. Wagner, Fargo, ND (US)

(73) Assignee: MICROSOFT CORPORATION, Redmond, WA (US)

(21) Appl. No.: 12/985,208

(22) Filed: Jan. 5, 2011

(51) Int. Cl. G06Q 10/00

(52) U.S. Cl. 705/7.11; 705/342

(57) ABSTRACT

A user interface may be provided for initiating communication of a business process from a single report user interface. The user interface may include a report area, a selected report in the report area and a group of integrated action buttons for initiating communication of one or more business processes against the selected report. The integrated action buttons in the user interface may be selected by a user to apply the one or more business processes against the selected report. The one or more business processes may then be initiated against the selected report from the user interface.

### CROSS-REFERENCE TO RELATED APPLICATIONS

This application is related to a U.S. utility patent application entitled “Displaying a Series of Reports within a Single User Interface” having Ser. No. ______ (attorney docket number 14917.1604US01/330888.01), which was filed on Jan. 5, 2011. The aforementioned application is entirely incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Business enterprises may utilize enterprise resource planning (“ERP”) and customer relationship management (“CRM”) software applications to organize, automate, and synchronize business processes, including data related to sales activities, marketing, human resources, customer service and technical support. The aforementioned business processes often result in the generation of various reports which may be utilized by administrators or other business personnel to facilitate the management of business data. For example, various reports may be generated to show historical changes in a particular business metric (such as sales data) over a user-specified time period. Data from these reports may then be visually presented to a user as a snapshot (e.g., a graph). However, current applications are unable to provide multiple snapshots of report data in a single view. Furthermore, users must navigate away from an application displaying a snapshot in order to access one or more different applications to initiate actions which are relevant to the report data upon which the snapshot is based. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for displaying a user interface which may be utilized for initiating communication of a business process from a single report user interface. The user interface may include a report area, a selected report in the report area and a group of integrated action buttons for initiating communication of one or more business processes against the selected report. The integrated action buttons in the user interface may be selected by a user to apply the one or more business processes against the selected report. The one or more business processes may then be initiated against the selected report from the user interface.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for initiating communication of a business process from a single report user interface, in accordance with various embodiments;

FIG. 2 is a block diagram illustrating a computing environment which may be utilized for initiating communication of a business process from a single report user interface, in accordance with various embodiments;

FIG. 3 is a computer screen display of a user interface which may be utilized for initiating communication of a business process, in accordance with various embodiments; and

FIG. 4 is a flow diagram illustrating a routine for initiating communication of a business process from a single report user interface, in accordance with an embodiment.

### DETAILED DESCRIPTION

Embodiments are provided for displaying a user interface which may be utilized for initiating communication of a business process from a single report user interface. The user interface may include a report area, a selected report in the report area and a group of integrated action buttons for initiating communication of one or more business processes against the selected report. The integrated action buttons in the user interface may be selected by a user to apply the one or more business processes against the selected report. The one or more business processes may then be initiated against the selected report from the user interface.

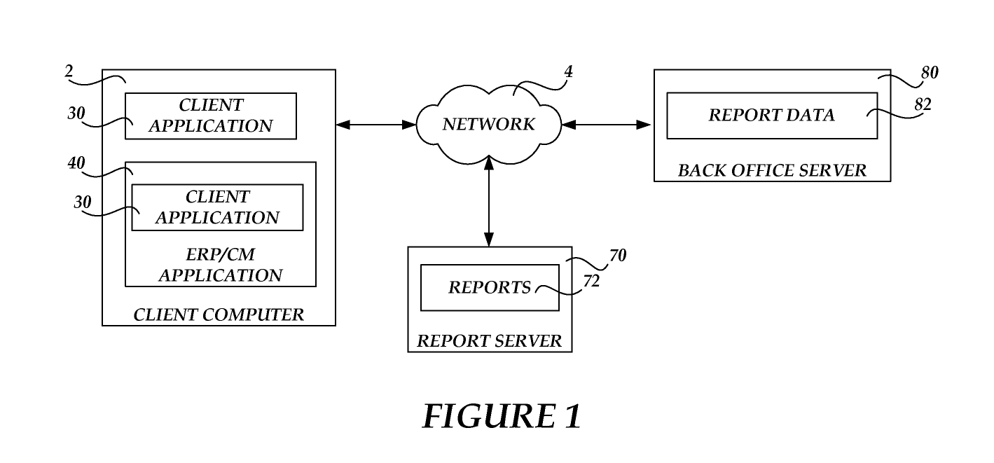

FIG. 1 is a block diagram illustrating a network architecture for initiating communication of a business process from a single report user interface, in accordance with various embodiments. The network architecture includes a client computer 2 in communication with a report server 70 which is in communication with a back office server 80 over a network 4. The network 4 may include a local network or a wide area network (e.g., the Internet). The client computer 2 may include a client application 30 or alternatively, an ERP/CM application 40 which includes the client application 30.

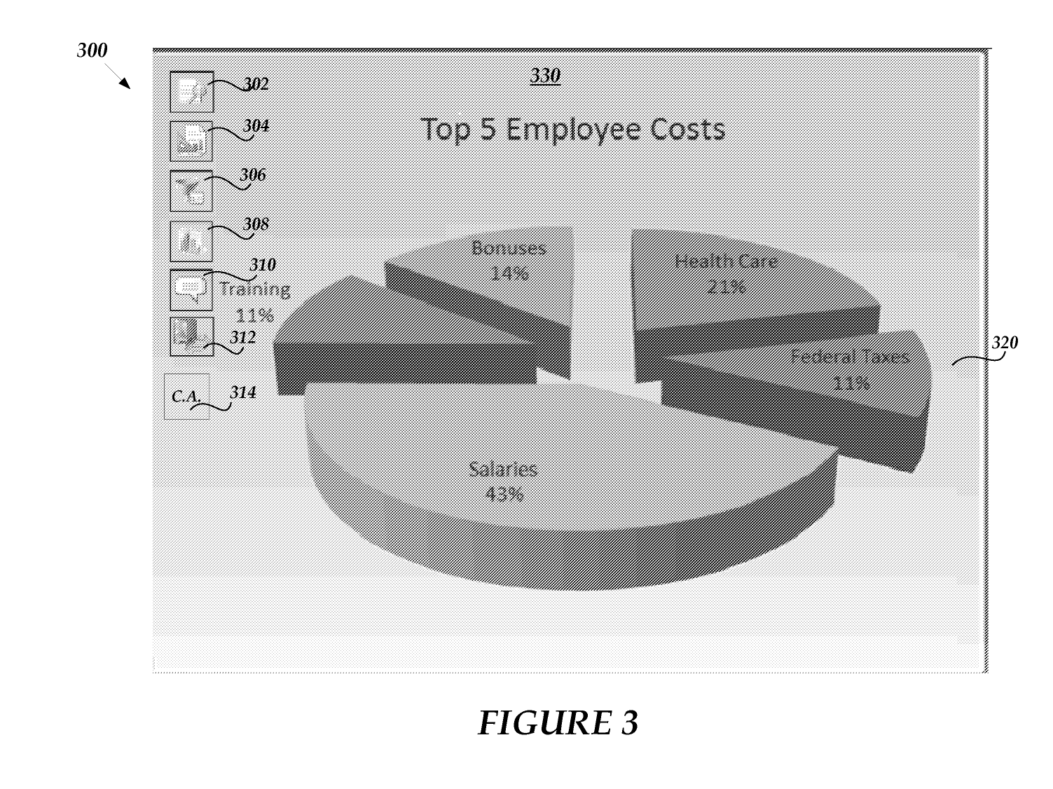

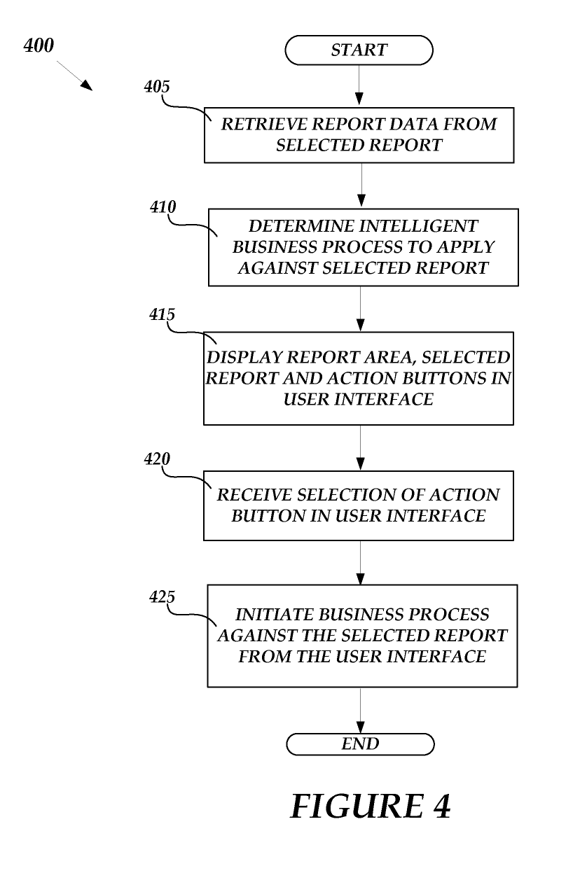

As will be described in greater detail with below respect to FIGS. 3-4, the client application 30 may comprise a software application operative to generate a user interface for displaying one or more reports (e.g., report images). The user interface may also include integrated action buttons for applying business processes against the reports.

In accordance with an embodiment, the ERP/CM application 40 may comprise an enterprise resource planning (“ERP”) and customer relationship management (“CRM”) software application which may be utilized to organize, automate, and synchronize business processes, including, but not limited to, data related to sales activities, marketing, human resources, customer service and technical support. The ERP/CM application 40 may optionally include the client application 30, discussed above. It should be understood, that in accordance with various embodiments, the client application 30 may act as a stand-alone application or may be utilized with the ERP/CM application 40. In accordance with an embodiment, the client application 30 and the ERP/CM application 40 may comprise the DYNAMICS line of ERP and CM software applications developed by MICROSOFT CORPORATION of Redmond, Wash. It should be appreciated, however, that ERP and/or CRM applications from other manufacturers may also be utilized in accordance with the various embodiments described herein.

The report server 70 may be utilized to store reports 72 which are generated from report data. The reports 72 may comprise various reports related to business processes such as sales reports, marketing reports, human resources reports, customer service reports and technical support reports. The reports 72 may also include other reports not enumerated in the aforementioned list which are related to enterprise resource planning and customer relationship management in an organization. In accordance with an embodiment, the report server 70 may comprise a database server such as the SQL SERVER relational model database server marketed by MICROSOFT CORPORATION of Redmond, Wash. It should be appreciated, however, that database servers from other manufacturers may also be utilized in accordance with the various embodiments described herein.

The back office server 82 may be utilized to store report data 82. The report data 82 may be utilized by the client application 30 and the ERP/CM application 40 to generate the reports 72 which are stored on the report server 70. As should be understood by those skilled in the art, a “back office” may include a part of a corporation or other business enterprise where tasks dedicated to running the company itself take place.

### Exemplary Operating Environment

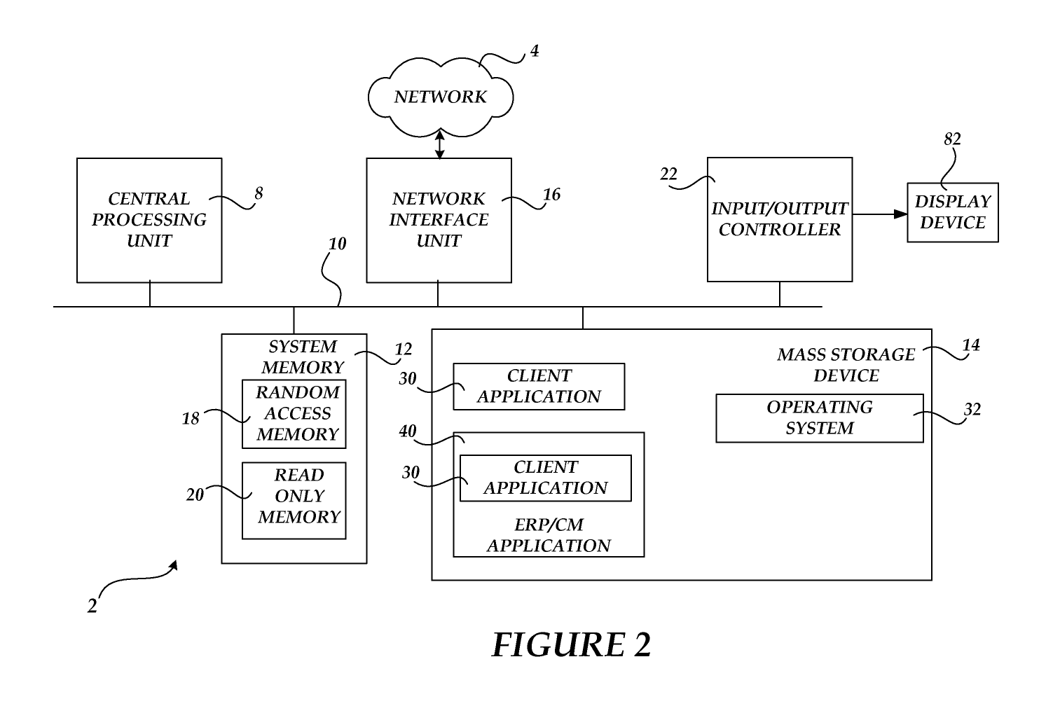

Referring now to FIG. 2, the following discussion is intended to provide a brief, general description of a suitable computing environment in which various illustrative embodiments may be implemented. While various embodiments will be described in the general context of program modules that execute in conjunction with program modules that run on an operating system on a computer, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with a number of computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 2 shows the client computer 2 which may include a general purpose desktop, laptop, tablet, or other type of computer capable of executing one or more application programs. The client computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

The client computer 2 further includes a mass storage device 14 for storing an operating system 32 and the client application 30 (or optionally, the ERP/CM application 40 which incorporates the client application 30). In accordance with various embodiments, the operating system 32 may be suitable for controlling the operation of a networked computer, such as the WINDOWS operating systems from MICROSOFT CORPORATION of Redmond, Wash. The mass storage device 14 is connected to the CPU 8 through a mass storage controller (not shown) connected to the bus 10. The mass storage device 14 and its associated computer-readable media provide non-volatile storage for the client computer 2. The term computer-readable media as used herein may include computer storage media. Computer storage media may include volatile and nonvolatile, removable and non-removable media implemented in any method or technology for storage of information, such as computer readable instructions, data structures, program modules, or other data. Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the client computer 2. Any such computer storage media may be part of the client computer 2.

The term computer-readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

According to various embodiments, the client computer 2 may operate in a networked environment using logical connections to remote computers through the network 4 which may comprise, for example, a local network or a wide area network (e.g., the Internet). The client computer 2 may connect to the network 4 through a network interface unit 16 connected to the bus 10. It should be appreciated that the network interface unit 16 may also be utilized to connect to other types of networks and remote computing systems. The client computer 2 may also include an input/output controller 22 for receiving and processing input from a number of input types, including a keyboard, mouse, pen, stylus, finger, and/or other means. Similarly, the input/output controller 22 may provide output to a display device 82, a printer, or other type of output device. Additionally, a touch screen can serve as an input and an output mechanism. It should be appreciated that the report server 70 and the back office server 80, shown in FIG. 1, may include many of the conventional components shown and discussed above with respect to the client computer 2.

FIG. 3 is a computer screen display of a user interface 300 which may be utilized for initiating communication of a business process, in accordance with various embodiments. The user interface 300 may be generated by the client application 30 (or alternatively, the client application 30 in use with the EP/CRM application 40) for display on the display device 82 connected to the client computer 2. The user interface 300 may display a report 330 consisting of a chart (e.g., a pie chart of “Top 5 Employee Costs”) in a report area 320. The user interface 30 may further include integrated action buttons 302-314 for initiating the communication of various business processes with respect to the report 330. In particular, integrated action buttons may comprise a “View” action button 302, an “Edit” action button 304, a “Change Date” action button 306, a “Trends” action button 308, a “Communicator” action button 310, a “Select Company” action button 312 (optional) and a custom action “C.A.” button 314. The View action button 302 may initiate a process in which a user is routed to a location (e.g., the report server 70) where the report is deployed and from where the report is rendered. In accordance with an embodiment, the client application 30 may be utilized in a “native” mode in which the View action button 302 may alternatively route a user to a report manager web page or a shared location where the report is deployed. The Edit action button 304 may initiate a process for editing a report. In particular, the process may launch a separate “Report Builder” application (not shown) and retrieve the report 330 shown in the report area 320 along with report parts that are available for a list type that the report was rendered from, for editing. For example, a user who is on a customer list, upon selecting the Edit action button 304, may initiate the following processes: (1) the launching of an SQL Report Builder application, (2) the retrieval of the report that the user has associated with the user interface 300, and (3) the display of various report parts related to customers on the customer list. The Change Date action button 306 may initiate a process in which a user is presented with selectable date tokens (e.g., today, yesterday, last week, last year and custom (for which the user may select the date of their choice)) for use in re-rendering the report 330 displayed in the report area 320 based on a selected data. When a user changes the date, the client application 30 may pass the new date to a date parameter associated with the report and re-render the report. The new date may be calculated automatically based on a computer system date. The Trends action button 308 may initiate a process in which a user is presented with selectable date ranges (e.g., last 7 days, last 30 days, last 90 days, last 6 months, last 12 months or a custom range) for use in re-rendering the report 330 as a trend report covering a selected date range. The Communicator action button 310 may initiate a process for any of a number of communication actions, including, but not limited to, sending an instant message, starting a video call, starting a voice call, sending a text message and sending an e-mail message, either directly from the user interface 300, from a unified communicator or from another communication application. In accordance with an embodiment, after a communication (e.g., an instant messaging conversation) is initiated, the name of the report 330 may be passed as the subject of the communication. In accordance with another embodiment, an initiated communication may include an image file (e.g., a JPEG file) of the report 330 as an attachment to the communication. The Select Company action button 312 may initiate a process which presents a menu listing company names for viewing various metrics. In accordance with an embodiment, a group of companies may be selected by a user so that the user may compare performance across multiple companies. The C.A. button 314 may be generated by the client application 30 for display in the user interface 300 for initiating any of a number of various intelligent business processes which the client application 30 may determine based on a selected report and report data. A non-exhaustive list of intelligent business processes which may be determined includes: sending a communication, creating a workflow, filling an inventory shortage, updating a credit limit, initiating a copy action, and initiating a purchase order. The determination of intelligent business processes by the client application 30 will be discussed in greater detail below with respect to FIG. 4.

FIG. 4 is a flow diagram illustrating a routine illustrating a routine 400 for initiating communication of a business process from a single report user interface, in accordance with an embodiment. When reading the discussion of the routine presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 4 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 400 begins at operation 405, where the client application 30 executing on the client computer 2 may retrieve report data from a selected report by a user. For example, a user may, from the user interface 300 of FIG. 3, select the report 330 for viewing in the report area 320. The client application 30 may then retrieve the report data 82 from the back office server 80 for the selected report.

From operation 405, the routine 400 continues to operation 410, where the client application 30 may determine, from the retrieved report data 82, one or more intelligent business processes (i.e., actions) to apply against the selected report 330 displayed in the user interface 300. For example, the client application 30 may determine from a selected report that the shipment of a product is late due to a product shortage, the client application 30 may then be configured to analyze the report data and determine a number of intelligent business processes the user may wish to take based on the selected report. Thus, for a late product shipment due to a product shortage, the client application 30 may determine that a communication should be sent to the customer affected by the late shipment and further determine that a product order should be placed in order to fill the shortage. As another example, the client application 30 may determine, from a selected report and associated report data, that a current inventory for a product is below a threshold. As a result, the client application 30 may determine that a purchase order should be placed to replenish a current stock of the product. As yet another example, the client application 30 may determine, from a selected compensation analysis report and associated report data, that a compensation change is needed in order to provide employees with a two percent raise. As a result, the client application 30 may determine a workflow for initiating a compensation change for the affected group of employees. As yet another example, the client application 30 may determine, from a customer loyalty report and associated report data, the top five customers for a particular company. The client application 30 may further determine that one of the top five customers is currently online (e.g., logged into the company's website). As a result, the client application may determine that the online customer should receive a message offering a discount on a product the online customer may be interested in.

From operation 410, the routine 400 continues to operation 415, where the client application 30 may display the user interface 300 including the report area 320, the selected report 330 and the action buttons 302-314.

From operation 415, the routine 400 continues to operation 420, where the client application 30 may receive a selection of an action button 302-314 in the user interface 300. In particular, a user may select one of the action buttons 302-312 to initiate predetermined business processes against the selected report 330 directly from the user interface 300. For example, a user may initiate a process for viewing a report, editing a report, re-rendering a report for a selected date, re-rendering a report over a selected date range (i.e., generate a trend report), sending a communication (such as an instant messenger message) associated with a report, and re-rendering a report based on one or more selected companies. Alternatively, or in addition, the user may select the custom action (C.A.) button 314 to initiate an intelligent business process, as determined by the client application 30, against the selected report 330 from the user interface 300. In accordance with an embodiment, the C.A. button 314 may be associated with one or more of intelligent business processes, discussed above at operation 410, which may be determined by the client application 30 For example, as discussed above at operation 410, intelligent business processes may include the following actions initiated directly from the user interface 300: sending a communication to a customer affected by a late shipment, placing a product order to fill an inventory shortage for a product, initiating a purchase order to replenish a current stock of a product, initiate a workflow for initiating a compensation change for a group of employees, or initiate a communication with a loyal customer, offer the loyal customer a discount on the purchase of a product, and create a purchase order for the product. It should be understood that all of the aforementioned business processes may be initiated directly from the user interface 300 (i.e., without the user leaving the displayed selected report 330 in order to access another application).

From operation 420, the routine 400 continues to operation 425, where the client application 30 may initiate one or more of the business processes in response to the selection of one or more of the action buttons 302-314 made at operation 420, from the user interface 300. From operation 425, the routine 400 ends.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

1. A method for initiating communication of a business process from a single report user interface, comprising:
displaying, by a computer, a user interface comprising:
a report area;
a selected report in the report area; and
a plurality of integrated action buttons for initiating communication of at least one business process against the selected report;
receiving, by the computer, a selection of at least one of the plurality of integrated action buttons in the user interface for applying the at least one business process against the selected report; and
initiating the at least one business process against the selected report from the user interface, the at least one business process comprising routing, from the user interface, to a report server for deploying and rendering the selected report, to view report data associated with the selected report.

2. The method of claim 1, wherein displaying, by the computer, a plurality of integrated action buttons for initiating communication of at least one business process against the selected report comprises displaying a plurality of integrated action buttons for initiating communication of a plurality of predetermined business processes against the selected report.

3. The method of claim 2, wherein displaying, by the computer, a plurality of integrated action buttons for initiating communication of a plurality of predetermined business processes against the selected report comprises displaying at least one of an edit action button, a view action button, a change date action button, a trends action button, a communication action button and a company selection action button.

4. The method of claim 1, further comprising:
prior to displaying, by the computer, the selected report in the report area, retrieving report data from the selected report; and
determining, from the report data, at least one intelligent business process to apply against the selected report.

5. The method of claim 1, wherein displaying, by the computer, a plurality of integrated action buttons for initiating communication of at least one business process against the selected report comprises displaying a custom action button for initiating communication of at least one intelligent business process against the selected report.

6. The method of claim 1, wherein receiving, by the computer, a selection of at least one of the plurality of integrated action buttons in the user interface for applying the at least one business process against the selected report comprises receiving a selection of at least one custom action button for initiating communication of at least one intelligent business process against the selected report.

7. The method of claim 1, wherein initiating the at least one business process against the selected report from the user interface comprises initiating at least one intelligent business process against the selected report from the user interface, wherein initiating the at least one intelligent business process comprises initiating at least one of sending a communication, creating a workflow, filling an inventory shortage and initiating a purchase order.

8. A computer system for initiating communication of a business process from a single report user interface, comprising:
a memory for storing executable program code; and
a processor, functionally coupled to the memory, the processor being responsive to computer-executable instructions contained in the program code and operative to:
display a user interface comprising:
a report area;
a selected report in the report area; and
a plurality of integrated action buttons for initiating communication of at least one business process against the selected report;
receive a selection of at least one of the plurality of integrated action buttons in the user interface for applying the at least one business process against the selected report; and
initiate the at least one business process against the selected report from the user interface, the at least one business process comprising routing, from the user interface, to a report server for deploying and rendering the selected report, to view report data associated with the selected report.

9. The system of claim 8, wherein the processor, in displaying a plurality of integrated action buttons for initiating communication of at least one business process against the selected report, is operative to display a plurality of integrated action buttons for initiating communication of a plurality of predetermined business processes against the selected report.

10. The system of claim 9, wherein the processor, in displaying a plurality of integrated action buttons for initiating communication of a plurality of predetermined business processes against the selected report, is operative to display at least one of an edit action button, a view action button, a change date action button, a trends action button, a communication action button and a company selection action button.

11. The system of claim 8, wherein the processor is further operative to:
prior to displaying the selected report in the report area, retrieve report data from the selected report; and
determine, from the report data, at least one intelligent business process to apply against the selected report.

12. The system of claim 8, wherein the processor, in displaying a plurality of integrated action buttons for initiating communication of at least one business process against the selected report, is operative to display a custom action button for initiating communication of at least one intelligent business process against the selected report.

13. The system of claim 8, wherein the processor, in receiving a selection of at least one of the plurality of integrated action buttons in the user interface for applying the at least one business process against the selected report, is operative to receive a selection of at least one custom action button for initiating communication of at least one intelligent business process against the selected report.

14. The system of claim 8, wherein the processor, in initiating the at least one business process against the selected report from the user interface, is operative to initiate at least one intelligent business process against the selected report from the user interface, wherein, in initiating the at least one intelligent business process, the processor is further operative to initiate at least one of sending a communication, creating a workflow, filling an inventory shortage and initiating a purchase order.

15. A computer-readable storage medium comprising computer executable instructions which, when executed by a computer, will cause the computer to perform a method for initiating communication of a business process from a single report user interface, the method comprising:
displaying a user interface comprising:
a report area;
a selected report in the report area; and
a plurality of integrated action buttons for initiating communication of at least one business process against the selected report, wherein displaying a plurality of integrated action buttons for initiating communication of at least one business process against the selected report comprises displaying a plurality of integrated action buttons for initiating communication of a plurality of predetermined business processes against the selected report;
receiving, by the computer, a selection of at least one of the plurality of integrated action buttons in the user interface for applying the at least one business process against the selected report; and
initiating the at least one business process against the selected report from the user interface, the at least one business process comprising routing, from the user interface, to a report server for deploying and rendering the selected report, to view report data associated with the selected report.

16. The computer-readable storage medium of claim 15, wherein displaying a plurality of integrated action buttons for initiating communication of a plurality of predetermined business processes against the selected report comprises displaying at least one of an edit action button, a view action button, a change date action button, a trends action button, a communication action button and a company selection action button.

17. The computer-readable storage medium of claim 15, further comprising:
prior to displaying the selected report in the report area, retrieving report data from the selected report; and
determining, from the report data, at least one intelligent business process to apply against the selected report.

18. The computer-readable storage medium of claim 15, wherein displaying a plurality of integrated action buttons for initiating communication of at least one business process against the selected report further comprises displaying a custom action button for initiating communication of at least one intelligent business process against the selected report.

19. The computer-readable storage medium of claim 15, wherein receiving a selection of at least one of the plurality of integrated action buttons in the user interface for applying the at least one business process against the selected report comprises receiving a selection of at least one custom action button for initiating communication of at least one intelligent business process against the selected report.

20. The computer-readable storage medium of claim 15, wherein initiating the at least one business process against the selected report from the user interface comprises initiating at least one intelligent business process against the selected report from the user interface, wherein initiating the at least one intelligent business process comprises initiating at least one of sending a communication, creating a workflow, filling an inventory shortage and initiating a purchase order.
